(19) United States
(12) Patent Application Publication
(10) Pub. No.: US 2020/0182346 A1
(43) Pub. Date: Jun. 11, 2020

(54) GEAR ASSEMBLY

(71) Applicant: GM GLOBAL TECHNOLOGY OPERATIONS LLC, DETROIT, MI (US)

(72) Inventors: Sean M. McGowan, Northville, MI (US); Mark R. Claywell, Birmingham, MI (US); Maqsood Rizwan Ali Khan, Rochester Hills, MI (US)

(21) Appl. No.: 16/214,719

(22) Filed: Dec. 10, 2018

(51) Int. Cl. F16H 57/00; F04C 2/18

(52) U.S. Cl. CPC F16H 57/0025; F04C 2/18; F05B 2250/182; F04C 2240/60; F04C 2210/206

(57) ABSTRACT

A gear assembly includes a primary shaft, a driving gear, a driven gear, a secondary shaft, and a key wherein the primary shaft and the driving gear define a keyway for housing the key. The primary shaft defines a lower region of the keyway while the driving gear defines an upper region of the keyway. The driving gear may be mounted on the primary shaft such that the upper region and the lower regions of the keyway are aligned with each other in order for the keyway to house the key. The driven gear may be mounted on the secondary shaft such that the driven gear may be in meshing engagement with the driven gear. The aforementioned keyway defines a peninsula in a center portion of the driving gear. The peninsula is configured to abut a key disposed within the keyway.

### TECHNICAL FIELD

The present disclosure generally relates to a gear assembly, and more specifically to an arrangement for mounting a gear to a shaft in an oil scavenge pump.

### BACKGROUND

Oil pumps are traditionally known for the purpose of drawing up the lubricating oil from an oil collector device. The pump has an oil pump housing wherein at least two pairs of gears are disposed. The pairs of gears may be connected on the suction side to a suction passage formed in the oil pump housing and on the delivery side to a delivery passage.

A gear oil pump for the supply of lubricating oil to an internal combustion engine are generally implemented in vehicles wherein the lubricating oil is delivered from a rear oil suction space of an oil collector housing of the internal combustion engine via a first pumping stage into the actual oil sump in order to be supplied from there via a second pumping stage to the main bearings of the crankshaft or the bearings of the camshaft, etc. Typically, an oil pump includes driving gear 118 affixed on shaft 112 as by drive key 130 in order to mount the driving gear 118 onto the shaft 112. (See FIG. 3). However, while the oil pump is operating and the shaft 112 is rotating, the key 130 may shift excessively in a radial direction within the keyway 116. Moreover, the corners 156 of the keyway 116 may experience concentrated and excessive stress at the keyway corner 156 when at least one edge 158 of the key 130 interferes with the corresponding corner 156 of the keyway.

### SUMMARY

The present disclosure provides a gear assembly which may be implemented in various components, including but not limited to an oil scavenge pump. The gear assembly includes a primary shaft, a driving gear, a driven gear, a secondary shaft, and a key wherein the primary shaft and the driving gear define a keyway for housing the key. The primary shaft defines a lower region of the keyway while the driving gear defines an upper region of the keyway. The driving gear may be mounted on the primary shaft such that the upper region and the lower regions of the keyway are aligned with each other in order for the keyway to house the key. The driven gear may be mounted on the secondary shaft such that the driven gear may be in meshing engagement with the driven gear. The aforementioned keyway defines a peninsula in a center portion of the upper region defined by the driving gear. The peninsula is configured to abut a key disposed within the keyway.

The gear assembly of the present disclosure defines a first load distribution region integral to a first side of the peninsula and a second load distribution region integral to a second side of the peninsula. The first load distribution region defines a first recess within the driving gear and the second load distribution region defines a second recess within the driving gear.

In another embodiment of the present disclosure, the key may define a first chamfer, a second chamber, and an upper surface disposed between the first and second chamfers. The upper surface of the key may be configured to abut the peninsula.

As indicated, the gear assembly of the present disclosure may be implemented in a variety of different components which include but are not limited to an oil scavenge pump.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 illustrates an example, non-limiting gear assembly of the present disclosure wherein the gear assembly is used in an oil scavenge pump.

FIG. 2 is an expanded view of the example, non-limiting gear assembly of the present disclosure in FIG. 1.

FIG. 3 illustrates a prior art gear assembly wherein the lateral edges of a traditional key is prone to interfere with at least one corner region of the traditional keyway thereby causing undesirable stress on the traditional driving gear.

FIG. 4A illustrates a first embodiment gear assembly of the present disclosure.

FIG. 4B illustrates a second embodiment gear assembly of the present disclosure.

FIG. 5 is an expanded schematic view of the first embodiment gear assembly in FIG. 4A.

FIG. 6 is an expanded schematic view of a third embodiment gear assembly of the present disclosure,

FIG. 7 is an expanded schematic view of a third embodiment gear assembly of the present disclosure,

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

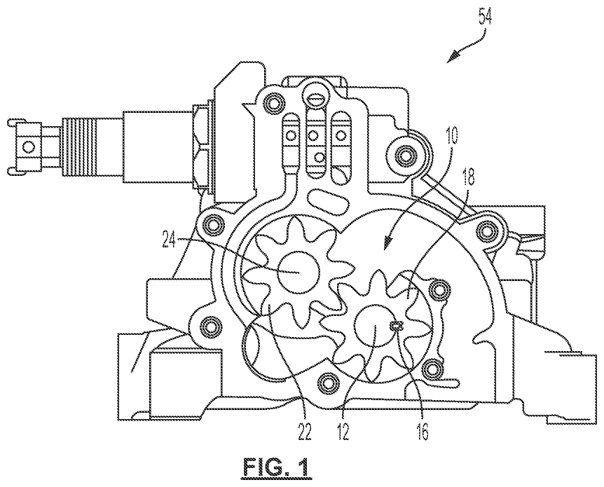

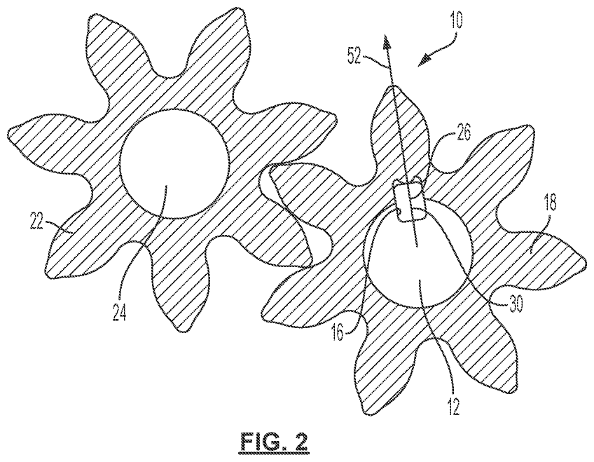

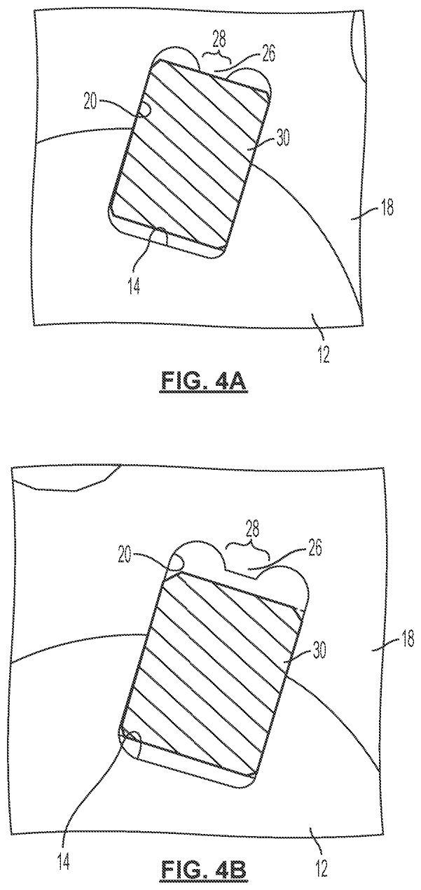

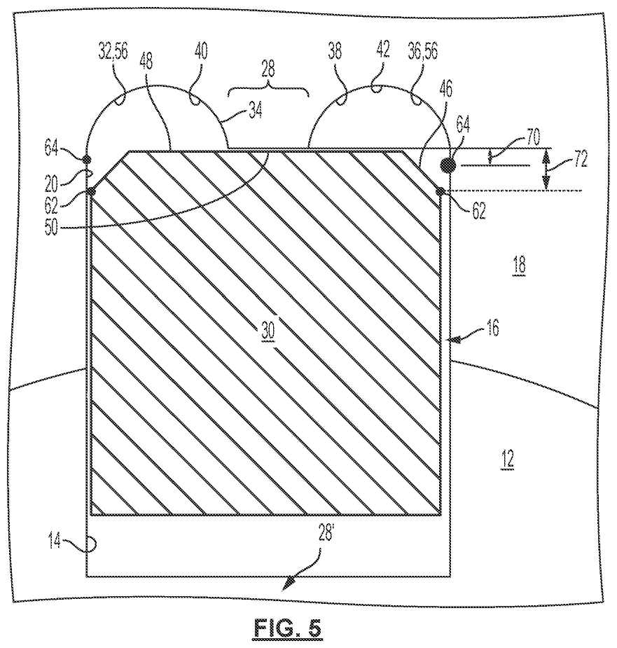

The present disclosure provides a gear assembly 10 which reduces the stress applied to a driving gear 18 wherein the driving gear 18 is mounted to a primary shaft 12 via a key 30. With respect all embodiments of the present disclosure, it is understood that key 30 is used to connect a rotating machine element (or torque transmitting component) shown as example element 18 in FIGS. 1, 2, and 4A-7. The rotating machine element (or torque transmitting component) may be, but not limited to a pulley, a shaft, a sprocket, a toothed gear, a hub, and a shaft) to a shaft 12. While terms driving gear and driven gear are implemented in the present disclosure, the term “gear” used in “driven gear,” “driving gear” and “gear assembly” in the present disclosure shall be construed to mean the aforementioned rotating machine element (or torque transmitting component) which may take various forms as indicated above. FIGS. 1-2, 4A-7 illustrate an example, non-limiting form of the rotating machine element (torque transmitting component) in the form of a toothed gear. It is understood that the present disclosure may be implemented in various components which implement a shaft-key interface (shown as elements 12 and 30 respectively)—including but not limited to an oil scavenge pump 54 as shown in FIG. 1. With reference to FIG. 2, the gear assembly 10 of the present disclosure includes a primary shaft 12, a driving gear 18, a driven gear 22, a secondary shaft, and a key 30 wherein the primary shaft 12 and the driving gear 18 define a keyway 16 for housing the key 30. As shown in the various embodiments of FIGS. 5-7, the primary shaft 12 defines a lower region 14 of the keyway 16 while the driving gear 18 defines an upper region 20 of the keyway 16. The driving gear 18 may be mounted on the primary shaft 12 such that the upper region 20 and the lower region 14 of the keyway 16 are aligned with each other in order for the keyway 16 to house the key 30. Referring back to FIG. 1, the driven gear 22 may be mounted on the secondary shaft such that the driven gear 22 may be in meshing engagement with the driving gear 18. As shown in FIGS. 5-7, the aforementioned keyway 16 defines a peninsula 26 in a center portion 28 of the upper region 20 defined by at least one of the driving gear 18 and/or the primary shaft 12. The example figures show the peninsula 26 being defined by the driving gear 18. Center portion 28′ of the primary shaft 12 is shown for reference only. As shown, the center portion 28 of the driving gear 18 is disposed between the first recess 40 and the second recess 42 which are later described herein. The peninsula 26 is configured to abut a key 30 disposed within the keyway 16. In the event the peninsula 26 is defined in the center portion 28′ of the primary shaft 12, then it is understood that primary shaft 12 will also similarly define first and second recesses (not shown) which would be defined on each side of the center portion 28′ or peninsula (not shown).

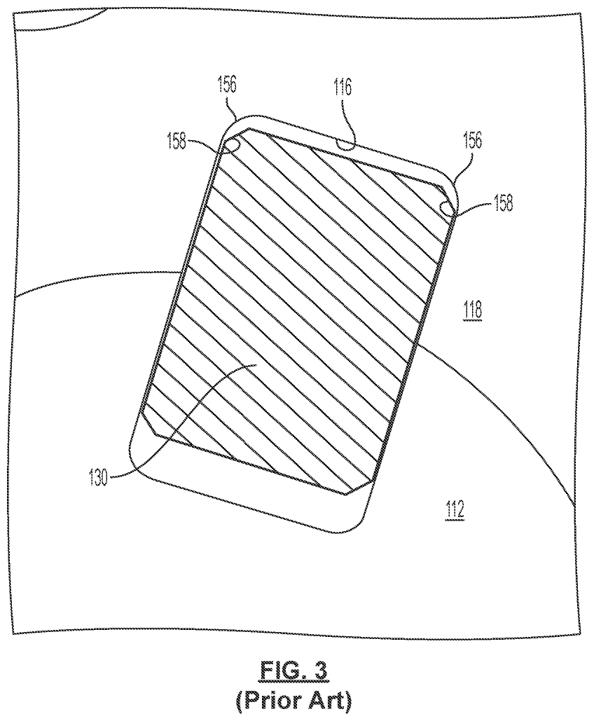

Referring again to FIGS. 57, the gear assembly 10 of the present disclosure defines a first load distribution region 32 integral to a first side 34 of the peninsula 26 and a second load distribution region 36 integral to a second side 38 of the peninsula 26. The peninsula 26 further defines an abutment portion 50 disposed between the first and second load distribution regions 32, 36. The abutment portion 50 of the peninsula 26 is configured, in part, to stop the key 30 from moving in an outward radial direction 52. The abutment portion 50 may be provided in a variety of ways—a flat surface (shown as non-limiting example element 50), a rounded surface, a point, etc.. The first load distribution region 32 defines a first recess 40 within the driving gear 18 and the second load distribution region 36 defines a second recess 42 within the driving gear 18. In the present disclosure, stress between the primary shaft 12 and the driven gear 22 is distributed over a larger region of the driven gear 22 relative to the prior art shown in FIG. 3 given that, in the present disclosure, the stress is distributed over: (1) the interface between the peninsula 26 and the upper surface 48 of the key 30; and (2) at least one load distribution region 32, 36 (of the first and second load distribution regions 32, 36). In sharp contrast to the present disclosure, the traditional key 130 shown in FIG. 3 is prone to exerting excessive and concentrated stress in a corner region 156 of the keyway 116 defined in the driving gear 118 when a key edge 158 abuts the corresponding keyway corner region 156 in the driving gear 118—depending upon whether the driving gear 118 and driving shaft 112 is rotating clockwise or counter-clockwise.

Moreover, as also shown in FIGS. 5-7, the key 30 may optionally define a first chamfer 44, a second chamfer 46, and an upper surface 48 disposed between the first and second chamfers 44, 46. The upper surface 48 of the key 30 may be configured to abut the peninsula 26 (or the abutment portion 50 of the peninsula 26). As indicated earlier, the gear assembly 10 of the present disclosure may be implemented in a variety of different components which include but are not limited to an oil scavenge pump 54 as shown in FIG. 1.

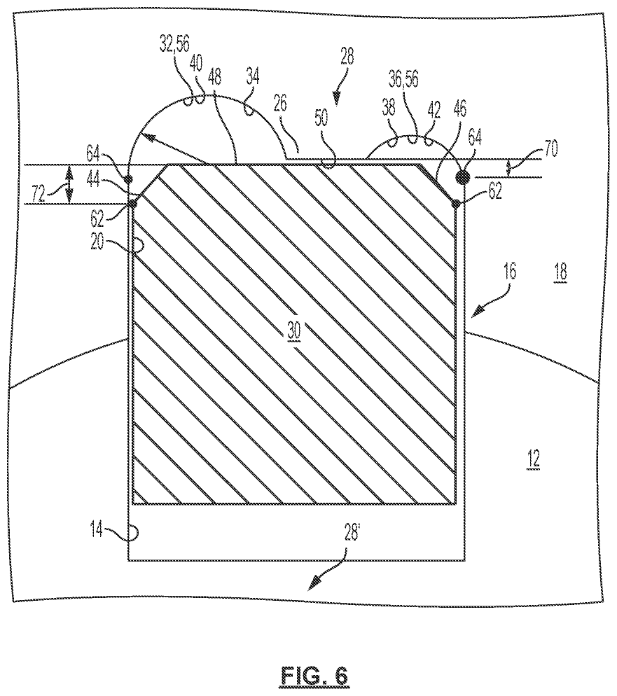

With reference to FIG. 5, the first and second load distribution regions 32, 36 are symmetric such that the driving gear 18 may optimally be implemented in both a clockwise direction and a counter clockwise direction. However, with reference to FIG. 6, the first load distribution region 32 is relatively larger than the second load distribution region 36 such that the driving gear in FIG. 6 may optimally be implemented in a driving gear 18 which has a torque that is predominantly in one direction (ex: a counter-clockwise direction)—such that the stress imposed on the driving gear 18 is distributed across the first load distribution region 32 and the abutment portion 50 of the peninsula 26. Therefore, as shown in in FIG. 6, the first recess is larger than the second recess and the peninsula may be biased toward the second recess within the center region of the keyway.

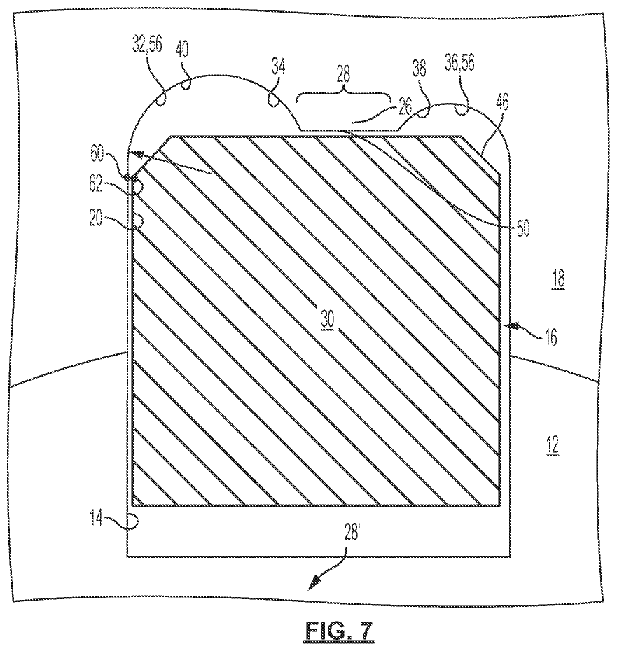

With reference to FIG. 7, another optimized design is shown where the first load distribution region 32 is increased (radius of first load distribution region is increased relative to the second load distribution region 36) such that the first load distribution region 32 terminates at a point 60 which is substantially aligned with a lower end 62 of the first chamfer 44. In contrast to FIG. 7, the first and second load distribution regions 32, 36 shown in FIGS. 5 and 6 may terminate at points 64 (at a first predetermined distance 70 from the peninsula 26) such that the lower end 62 of each chamfer 44, 46 (disposed at a second predetermined distance 72 from the upper surface 48) do not interfere with or abut the lower end/point 64 of the corresponding distribution region 32, 36 when the upper surface 48 of the key 30 abuts the abutment portion 50 of peninsula 26. Again, as indicated above, the gear (used in the terms “driving gear” and/or “driven gear” and which is illustrated in the various non-limiting examples of the present disclosure) should be construed to mean any torque transmitting component, such as but not limited to a pulley, a toothed gear, a worm gear, and a shaft.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A gear assembly comprising:
a primary shaft defining a lower region of a keyway;
a driving gear defining an upper region of the keyway and being mounted on the primary shaft to align the upper region and the lower region of the keyway; and
a driven gear mounted on a secondary shaft, the driven gear being in engagement with the driving gear;
wherein the keyway defines a peninsula in a center portion of at least one of the driving gear and the primary shaft and the peninsula is configured to abut a key disposed within the keyway.

2. The gear assembly as defined in claim 1 further comprising a first load distribution region integral to a first side of the peninsula and a second load distribution region integral to a second side of the peninsula.

3. The gear assembly as defined in claim 2 wherein the first load distribution region defines a first recess within the driving gear and the second load distribution region defines a second recess within the driving gear.

4. The gear assembly as defined in claim 3 wherein the key defines a first chamfer, a second chamfer, and an upper surface disposed between the first and second chamfers.

5. The gear assembly as defined in claim 4 wherein the upper surface of the key is configured to abut the peninsula.

6. The gear assembly as defined in claim 5 wherein the peninsula further defines an abutment portion disposed between the first and second load distribution regions and the abutment portion of the peninsula is configured to stop the key from moving in an outward radial direction.

7. The gear assembly as defined in claim 5 wherein the driving gear and the driven gear are disposed within an oil scavenge pump.

8. The gear assembly as defined in claim 1 wherein the driving gear is a torque transmitting component.

9. The gear assembly as defined in claim 6 wherein the abutment portion is a flat surface.

10. The gear assembly as defined in claim 3 wherein the first recess is larger than the second recess.

11. The gear assembly as defined in claim 3 wherein the peninsula is biased toward the second recess within the center portion of the keyway.
